(19) United States
(12) Patent Application Publication
(10) Pub. No.: US 2026/0286104 A1
(43) Pub. Date: Sep. 24, 2026

(54) RUBBER BLENDS CONTAINING ETHOXYLATED ALCOHOL

(71) Applicant: LANXESS Deutschland GmbH, Cologne (DE)

(72) Inventors: Melanie Wiedemeier-Jarad, Dormagen (DE); Irene Moll, Neuss (DE); Michaela Meiers, Aachen (DE); Hermann-Josef Weidenhaupt, Pulheim (DE)

(73) Assignee: LANXESS Deutschland GmbH, Cologne (DE)

(21) Appl. No.: 18/873,756

(22) PCT Filed: Jun. 16, 2023
(86) PCT No.: PCT/EP2023/066289

§ 371 Date: Dec. 11, 2024

(30) Foreign Application Priority Data
Jun. 23, 2022 (EP) 22180723.3
Feb. 16, 2023 (EP) 23156954.2

(51) Int. Cl. C08K 13/02; B60C 1/00; C08K 3/06; C08K 3/36; C08K 5/06; C08K 5/548; C08L 9/06

(52) U.S. Cl. CPC C08K 13/02; B60C 1/0016; B60C 1/0025; C08L 9/06; B60C 2001/0033; C08K 3/06; C08K 3/36; C08K 5/06; C08K 5/548; C08K 2201/005; C08L 2205/025; C08L 2312/00

(57) ABSTRACT

The invention relates to rubber blends that contain, in addition to specific amounts of synthetic rubber, fillers and cross-linking agents, 0.5 to 10 phr of the at least one ethoxylated compound of formula (I): RO(CH₂CH₂O)ₓH, wherein R represents alkyl, and the alkyl can be branched or unbranched, and x represents an integer between 1 and 20, and that are suitable for producing vulcanized products having a low rolling resistance.

The invention relates to novel rubber mixtures containing at least one ethoxylated compound of formula (I), to processes for the production thereof, to the use thereof for producing rubber vulcanizates, to the corresponding vulcanizates and to the use of at least one ethoxylated compound of formula (I) in rubber mixtures, vulcanizates and shaped articles obtainable therefrom for reducing the rolling resistance of shaped articles containing these vulcanizates, preferably of tires.

The EU is obligated to reduce its greenhouse gas emissions to achieve climate neutrality by 2050. Reducing CO₂ emissions from road traffic plays a major role in achieving these targets.

A new EU tire labeling system, which entered into force on May 1, 2021, is based on three important tire characteristics: Rolling resistance—and thus fuel efficiency—, wet grip and external rolling noise. The new EU tire label will allow consumers to actively choose more fuel-efficient tires.

More fuel-efficient tires contribute to reducing emissions in road traffic. Depending on the rolling resistance of the tire, fuel efficiency ranges from Class A (best fuel efficiency) to Class E. Fuel consumption is important from both economic and environmental standpoints. Low fuel consumption has a positive effect on the CO₂ balance of the vehicle, especially for heavy commercial vehicles.

Against this backdrop, tire manufacturers are looking for economic ways to achieve the Class A fuel efficiency target for tires.

The use of silica-containing rubber mixtures for the production of passenger car tire treads is known. The silica contributes to a good combination of properties comprising rolling resistance, wet grip and abrasion as are required for passenger car tire treads. To achieve the desired combination of properties the silica must be efficiently dispersed in the rubber mixture and optimally coupled to the rubber matrix in the vulcanization.

To improve the processability of silica-containing rubber mixtures it is possible to employ further additives such as for example fatty acid esters, fatty acid salts or mineral oils. The aforementioned additives have the disadvantage that they increase flowability but simultaneously reduce stress values at higher elongation (e.g. 100% to 300%) or else reduce the hardness of the vulcanizates, thus adversely affecting the reinforcing effect of the filler.

However, insufficient hardness or stiffness of the vulcanizate results in inadequate driving characteristics of the tire, particularly during cornering.

The loss factor tan δ provides an important indication for assessing rolling resistance. The lower the loss factor tan δ, the lower the rolling resistance. The loss factor tan δ should be as low as possible at 60° C. to 70° C.; <0.2 according to U.S. Pat. No. 9,783,658B2 and <0.12 according to EP 2858831A2.

EP2858831A2 discloses that rubber mixtures containing 1 phr of 1,6-bis(N,N-dibenzylthiocarbamoyldithio)hexane (CAS No: 151900-44-6) and 1 phr of certain sulfur-containing additives results in vulcanizates having good dynamic characteristics, good hardness/stiffness, good rolling resistance and low abrasion. A disadvantage is that the scorch time (t5) is significantly reduced during vulcanization of this rubber mixture, which is a major disadvantage in terms of processing reliability. From the standpoint of the rubber processing industry, it is also more advantageous to use just a few mixture components.

In U.S. Pat. No. 9,376,551A1, rolling resistance is reduced by adding certain organosilicon polysulfides. The results in table 2 of U.S. Pat. No. 9,376,551A1 show that 1 phr of the organosilicon polysulfide reduces the loss factor (tan δ at 60° C.) by more than 10 percent. The mechanical properties such as tensile strength, breaking elongation and 300 modulus remained virtually unchanged. Here too, it is a disadvantage that the scorch time is drastically reduced by addition of the organosilicon polysulfide.

It was accordingly an object of the present invention to provide improved rubber mixtures based on a hydroxyl-containing oxidic filler which overcome the aforementioned disadvantages and lead to vulcanizates and shaped articles produced therefrom such as tire treads having a low rolling resistance measured by the loss factor tan δ at 60° C. coupled with virtually unchanged properties such as 300 modulus and hardness. The improved rubber mixtures should preferably also have reduced complete vulcanization times (195). The improved rubber compounds should also preferably have a low rolling resistance measured by the loss factor tan δ at 60° C. at unchanged 300 modulus and hardness.

A low loss factor tan δ at 60° C. determined by DIN 53513 dynamic damping is preferably less than 0.2, particularly preferably less than 0.12.

The scorch time t5 determined according to ASTM D5289-95 at 130° C. is preferably in the range of 1000-1500 seconds, particularly preferably in the range of 1300-1500 seconds.

A short complete vulcanization time 195 (95% conversion time) determined according to ASTM D5289-95 at a temperature of 170° C. is preferably in the range of 500-1000 seconds.

A high 300 modulus value is also advantageous for vulcanizates, in particular for the tire treads. The 300 modulus (determined according to DIN 53504) is preferably 10-25 MPa.

The hardness determined according to DIN53505 should be in a range of 60-75 Shore A.

The unit “phr” hereinbelow stands for parts by weight based on 100 parts by weight of the total amount of rubber present in the rubber mixture, i.e. the total amount of synthetic rubber(s) and natural rubber(s).

The above object is surprisingly achieved by rubber mixtures according to the invention containing
50 to 100 phr of at least one synthetic rubber, preferably BR rubber and/or SBR rubber,
0 to 50 phr of at least one natural rubber,
0.1 to 200 phr of at least one hydroxyl-containing oxidic filler,
0 to 120 phr of at least one carbon black, preferably 0.1 to 100 phr,
0.1 to 20 phr of at least one crosslinker, preferably selected from the group of sulfur donors and/or sulfur,
and
0.5 to 10 phr of at least one ethoxylated compound of formula (I)

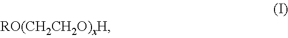

wherein
R represents alkyl, wherein alkyl may be branched or unbranched,
and
x represents an integer from 1 to 20.

The vulcanizates according to the invention obtained by vulcanization of the rubber mixtures according to the invention surprisingly feature a low loss factor tan δ at 60° C. as well as a short complete vulcanization time (195) while retaining equally good performance characteristics such as 300 modulus, hardness and vulcanization characteristics.

### Rubbers

The rubber mixtures according to the invention contain at least one synthetic rubber, preferably selected from the group consisting of polar and non-polar synthetic rubbers.

Preferred polar and non-polar synthetic rubbers are

| | |
|---|---|
| BR | polybutadiene |
| ABR | butadiene/C1-C4-alkyl acrylate copolymer |
| CR | polychloroprene |
| IR | polyisoprene |
| SBR | styrene/butadiene copolymers having styrene |
| | contents of 1-60%, preferably 20-50%, by weight |
| IIR | isobutylene/isoprene copolymers |
| NBR | butadiene/acrylonitrile copolymers having |
| | acrylonitrile contents of |
| | preferably 10-50%, by weight |
| HNBR | partially or fully hydrogenated NBR rubber |
| EPDM | ethylene/propylene/diene copolymers |
| SIBR | styrene-isoprene-butadiene rubber |
| ENR | epoxidized natural rubber |
| SNBR | acrylonitrile-styrene/butadiene rubber |
| HNBR | hydrogenated acrylonitrile/butadiene rubber |
| XNBR | carboxylated acrylonitrile/butadiene rubber |
| HXNBR | hydrogenated carboxylated arcylnitrile/butadiene rubber |

The at least one synthetic rubber is preferably selected from the group consisting of SBR and BR rubber.

It is preferable when the rubber mixtures according to the invention contain at least one SBR rubber and/or a BR rubber, particularly preferably an SBR rubber and a BR rubber.

The SBR rubber may be a functionalized SBR rubber.

Functionalized SBR rubber is to be understood as meaning an SBR rubber which is substituted at the main chain and/or at the end groups by one or more functional groups, in particular carboxyl groups and/or mercaptan-containing groups.

In a preferred embodiment the rubber mixtures according to the invention contain at least one functionalized SBR rubber and optionally one or more BR rubbers.

The rubber mixtures according to the invention contain 50 to 100 phr of at least one synthetic rubber, preferably 70-100 phr.

The rubber mixtures according to the invention preferably contain at least one SBR and at least one BR rubber in the weight ratio SBR:BR of 100:0 to 0:100, particularly preferably of 90:10 to 10:90, very particularly preferably of 90:10 to 50:50, very very particularly preferably of 80:20 to 60:40.

In an alternative advantageous embodiment the rubber mixtures according to the invention contain at least one natural rubber. The inventive rubber mixtures may contain 0 to 50 phr of natural rubber, preferably 0-30 phr.

### Ethoxylated Compound of Formula (I)

The rubber mixtures according to the invention contain at least one ethoxylated compound of formula (I)

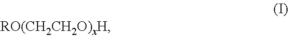

wherein
R represents alkyl, wherein alkyl may be branched or unbranched,
and
x represents an integer from 1 to 20.
R preferably represents C₁-C₂₀-alkyl, particularly preferably C₅-C₁₇-alkyl, very particularly preferably C₁₀-C₁₅-alkyl, very very particularly preferably iso-C₁₃-alkyl, most preferably iso-C₁₃H₂₇.
x preferably represents an integer from 2 to 15, particularly preferably from 3 to 10, very particularly preferably from 4 to 6, most preferably of 5.

At least one ethoxylated compound of formula (I) is present for example in LUTENSOL® TO 5 from BASF.

The rubber mixtures according to the invention generally contain the at least one ethoxylated compound of formula (I) in an amount of 0.5 to 10.0 phr, preferably of 1.0 to 8.0 phr, particularly preferably of 2.0 to 7.0 phr and very particularly preferably of 4.0 to 6.0 phr.

### Fillers

The at least one hydroxyl-containing oxidic filler is preferably selected from the group consisting of silica, synthetic silicates and natural silicates.

The content of hydroxyl-containing oxidic fillers in the rubber mixtures according to the invention is 0.1 to 200 phr, preferably 20 to 160 phr, particularly preferably 25 to 140 phr and very particularly preferably 30 to 120 phr.

Suitable hydroxyl-containing oxidic fillers are preferably those selected from the group of
silicas, in particular having a specific surface area (BET) of 5 to 1000, preferably 20 to 400, m²/g, preferably having primary particle sizes of 100 to 400 nm, wherein the silicas may optionally also be present as mixed oxides with other metal oxides, such as Al, Mg, Ca, Ba, Zr, Ti oxides,
synthetic silicates, such as aluminum silicate, alkaline earth metal silicates such as magnesium silicate or calcium silicate, having specific surface areas (BET) of 20 to 400 m²/g, preferably having primary particle sizes of 10 to 400 nm,
and
natural silicates, such as kaolin and other naturally occurring silicas,
and mixtures thereof.

The aforementioned BET surface areas are determined according to DIN ISO 9277. The indicated primary particle sizes are based on measurements using an instrument for particle analysis using scattered light. The calculation of particle size is based on Mie theory which describes the interaction between light and matter (DIN/ISO 13320).

It is preferable when the silicas are obtainable by precipitation of solutions of silicates or flame hydrolysis of silicon halides.

It is preferable when the rubber mixtures according to the invention contain at least one hydroxyl-containing oxidic filler from the group of silicas, especially having a specific surface area (BET) in the range from 5 to 1000, preferably 20 to 400, m²/g in an amount of 0.1 to 200 phr, preferably 20 to 160 phr, particularly preferably of 25 to 140 phr, very particularly preferably 30-120 phr.

The rubber mixtures according to the invention may contain at least one carbon black as filler.

In a preferred embodiment the rubber mixtures according to the invention contain at least one carbon black as filler.

The rubber mixtures of the invention preferably contain at least one carbon black in an amount of 0.1 to 120 phr, preferably 0.1 to 100 phr, particularly preferably 1 to 70 phr, very particularly preferably 2 to 40 phr.

Preference is given to carbon blacks that are obtainable by the lamp black, furnace black or gas black method and have a specific surface area (BET) in the range from 20 to 200 m²/g, for example SAF, ISAF, IISAF, HAF, FEF or GPF carbon blacks. The rubber mixtures of the invention preferably contain at least one carbon black having a specific surface area (BET) in the range from 20 to 200 m²/g.

It is preferable when the rubber mixtures according to the invention contain at least one of the aforementioned silicas and at least one of the aforementioned carbon blacks as fillers.

It is very particularly preferable when the rubber mixtures according to the invention contain 25 to 140 phr, preferably 30 to 120 phr, of at least one of the aforementioned silicas and 1.0 to 70 phr, preferably 2.0 to 40 phr, of at least one of the aforementioned carbon blacks as fillers.

The total amount of carbon black and silica-based fillers in the rubber mixture according to the invention is preferably 26 to 210 phr, particularly preferably 32 to 160 phr.

### Crosslinkers and Vulcanization Accelerators

The rubber mixtures according to the invention may contain one or more crosslinkers.

It is preferable when the rubber mixtures according to the invention contain at least one crosslinker from the group of sulfur and sulfur donors.

Sulfur may be used in elemental soluble or insoluble form.

It is particularly preferable when the rubber mixtures according to the invention contain at least one sulfur donor and/or sulfur, very particularly preferably sulfur.

Examples of suitable sulfur donors include dimorpholyl disulfide (DTDM), 2-morpholinodithiobenzothiazole (MBSS), caprolactam disulfide, dipentamethylenethiuram tetrasulfide (DPTT), tetramethylthiuram disulfide (TMTD) and tetrabenzylthiuram disulfide (TBzTB).

The rubber mixtures according to the invention generally contain 0.1 to 20 phr, preferably 0.5 to 10 phr and particularly preferably from 1.0 to 8 phr of the at least one crosslinker from the group of sulfur and sulfur donors.

In a particularly preferred embodiment the rubber mixtures according to the invention contain 0.1 to less than 1.8 phr, very particularly preferably 1.0 to 1.7 phr, very very particularly preferably 1.3 to 1.7 phr, of sulfur in the at least one crosslinker.

In an alternative particularly preferred embodiment the rubber mixtures according to the invention contain 1.8 to 20 phr, very particularly preferably 1.9 to 8.0 phr, very very particularly preferably 1.9 to 5 phr, most preferably 1.9 to 3 phr, of sulfur in the at least one crosslinker.

This last-mentioned embodiment achieves the additional object of providing improved rubber mixtures having a particularly low rolling resistance measured by the loss factor tan δ at 60° C. at unchanged 300 modulus and hardness.

The term “phr of sulfur in the at least one crosslinker” in the two aforementioned embodiments indicates that the aforementioned phr of sulfur refer to the amount of sulfur in the at least one crosslinker and thus also to sulfur employed in the form of a sulfur donor.

Rubber mixtures according to the invention may also contain zinc oxide. This is a complexing agent for sulfur and sulfur donors and thus simplifies the bonding of the sulfur to the rubber matrix.

Preferred rubber mixtures according to the invention contain zinc oxide having a BET surface of 2 to 100 m²/g, preferably 2 to 70 m²/g. BET surface areas of zinc oxide may be measured according to DIN ISO 9277.

Zinc oxide is generally present in the rubber mixtures according to the invention in an amount of 0 to 20 phr, preferably of 0.1 to 10 phr, particularly preferably of 1 to 5 phr.

The rubber mixtures according to the invention may contain one or more vulcanization accelerators.

The rubber mixtures according to the invention preferably contain at least one vulcanization accelerator, particularly preferably from the group of mercaptobenzothiazoles, thiocarbamates, dithiocarbamates, thiurams, thiazoles, sulfenamides, thiazolesulfenamides, xanthates, bi- or polycyclic amines, thiophosphates, dithiophosphates, caprolactams, thiourea derivatives, guanidines, cyclic disulfanes and amines, in particular zinc diaminediisocyanate, hexamethylenetetramine, 1,3-bis(citraconimidomethyl)benzene, and very particularly preferably from the group of the sulfenamides, very particularly preferably N-cyclohexylbenzothiazolesulfenamide (CAS No.: 95-33-0).

The rubber mixtures of the invention comprise generally 0.1 to 20 phr, preferably 0.5 to 10 phr and more preferably 1.0 to 5 phr of at least one of the vulcanization accelerators mentioned.

The rubber mixtures of the invention preferably contain at least one crosslinker and at least one vulcanization accelerator.

The rubber mixtures of the invention particularly preferably contain at least one crosslinker from the group of sulfur and sulfur donors and at least one vulcanization accelerator from the group of mercaptobenzothiazoles, thiazolesulfenamides, thiurams, dithiocarbamates, xanthates and thiophosphates, particularly preferably from the group of sulfenamides, very particularly preferably N-cyclohexylbenzothiazolesulfenamide (CAS No.: 95-33-0).

The rubber mixtures of the invention particularly preferably contain at least one crosslinker selected from the group consisting of sulfur and sulfur donors, at least one vulcanization accelerator selected from the group consisting of mercaptobenzothiazoles, thiazolesulfenamides, thiurams, dithiocarbamates, xanthates and thiophosphates, particularly preferably from the group of sulfenamides, very particularly preferably N-cyclohexylbenzothiazole-2-sulfenamide (CAS No.: 95-33-0) and zinc oxide.

The total amount of crosslinkers and vulcanization accelerators in the rubber mixtures is preferably 1.0 to 20 phr, particularly preferably from 2.0 to 13 phr.

### Reinforcing Additives

The rubber mixtures according to the invention may contain one or more reinforcing additives.

The rubber mixtures according to the invention preferably contain at least one reinforcing additive from the group of sulfur-containing organic silanes, in particular sulfur-containing silanes containing alkoxysilyl groups and very particularly preferably sulfur-containing organic silanes containing trialkoxysilyl groups.

It is particularly preferable when the rubber mixtures according to the invention contain one or more sulfur-containing silanes from the group of bis(triethoxysilylpropyl)tetrasulfane, bis(triethoxysilylpropyl)disulfane and 3-(triethoxysilyl)-1-propanethiol.

Liquid sulfur-containing silanes may be absorbed on a carrier (dry liquid) for better meterability and/or dispersibility. The content of sulfur-containing silanes in these “dry liquids” is preferably between 30 and 70 parts by weight, particularly preferably between 40 and 60 parts by weight, per 100 parts by weight of dry liquid.

The rubber mixtures of the invention contain generally 0.1 to 20 phr, preferably 0.5 to 15 phr and more preferably 1.0 to 10 phr of at least one reinforcing additive.

### Rubber Auxiliaries

The rubber mixtures according to the invention may further contain one or more rubber auxiliaries. Examples of suitable rubber auxiliaries include aging stabilizers, bonding agents, heat stabilizers, light stabilizers, flame retardants, processing aids, impact modifiers, plasticizers, tackifiers, blowing agents, dyes, pigments, waxes, extenders, organic acids such as stearic acid, retarders, in particular triethanolamine, polyethylene glycol, hexanetriol, reversion stabilizers and secondary accelerators

These rubber auxiliaries may be added to the rubber mixtures according to the invention in the amounts which are customary for these auxiliaries and are also guided by the end use of the vulcanizates produced therefrom. Customary amounts are, for example, 0.1 to 30 phr.

The rubber mixtures according to the invention may contain one or more aging stabilizers. Suitable aging stabilizers are aminic aging stabilizers, for example diaryl-p-phenylenediamines (DTPD), octylated diphenylamine (ODPA), phenyl-α-naphthylamine (PAN), phenyl-β-naphthylamine (PBN), preferably those based on phenylenediamine, for example N,N′-dicyclohexyl-p-phenylenediamine (CCPD), N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD), N,N′-bis(1,4-dimethylpentyl)-p-phenylenediamine (77PD), and phosphites such as s tris(nonylphenyl) phosphite, polymerized 2,2,4-trimethyl-1,2-dihydroquinoline (TMQ), methyl-2-mercaptobenzimidazole (MMBI) and zinc methylmercaptobenzimidazole (ZMMBI) and mixtures thereof. It is particularly preferable when the at least one aging stabilizer is selected from the group consisting of N,N′-dicyclohexyl-p-phenylenediamine (CCPD) and N-1,3-dimethylbutyl-N′-phenyl-p-phenylenediamine (6PPD).

Processing aids should be active between the rubber particles and should counter frictional forces during mixing, plasticizing and forming. Processing aids which may be present in the rubber mixtures according to the invention include all lubricants customary for the processing of plastics, for example hydrocarbons, such as oils, paraffins and PE waxes, fatty alcohols having 6 to 20 carbon atoms, ketones, carboxylic acids, such as fatty acids and montanic acids, oxidized PE wax, metal salts of carboxylic acids, carboxamides and carboxylic esters, for example with the alcohols ethanol, fatty alcohols, glycerol, ethanediol, pentaerythritol and long-chain carboxylic acids as the acid component.

To reduce flammability and to reduce smoke evolution on combustion, the rubber mixtures of the invention may contain flame retardants. Examples of compounds used for this purpose include antimony trioxide, phosphoric esters, chloroparaffin, aluminum hydroxide, boron compounds, zinc compounds with the exception of ZnO, molybdenum trioxide, ferrocene, calcium carbonate or magnesium carbonate.

Further plastics may also be added to the rubber mixtures of the invention prior to the crosslinking, these acting for example as polymeric processing aids or impact modifiers. These plastics are preferably selected from the group consisting of homo- and copolymers based on ethylene, propylene, butadiene, styrene, vinyl acetate, vinyl chloride, glycidyl acrylate, glycidyl methacrylate, acrylates and methacrylates having alcohol components of branched or unbranched C1 to C10 alcohols, particular preference being given to polyacrylates having identical or different alcohol radicals from the group of C4 to C8 alcohols, in particular of butanol, hexanol, octanol and 2-ethylhexanol, polymethylmethacrylate, methyl methacrylate-butyl acrylate copolymers, methyl methacrylate-butyl methacrylate copolymers, ethylene-vinyl acetate copolymers, chlorinated polyethylene, ethylene-propylene copolymers, ethylene-propylene-diene copolymers.

Known bonding agents are based on resorcinol, formaldehyde and silica, the so-called RFS direct bonding systems. These direct bonding systems may be employed in any desired amount of the rubber mixture according to the invention at any time of incorporation into the rubber mixtures according to the invention.

In silica-based rubber mixtures, such as are preferably employed for tire production, diphenylguanidine (DPG) or structurally similar aromatic guanidines are typically employed as secondary accelerators.

A person skilled in the art is aware that DPG may be advantageously substituted by 1,6-bis(N,N-dibenzylthiocarbamoyldithio)hexane which is also known by the trade name Vulcuren®. Substitution of DPG by a secondary accelerator such as TBzTD (tetrabenzylthiuram disulfide) or dithiophosphates is also possible.

The rubber mixtures according to the invention generally contain 0 or from 0.1 to 10 phr, preferably 0.5 to 5 phr, particularly preferably 0.2 to 3.5 phr, of at least one of the secondary accelerators mentioned.

Particular preference is given to rubber mixtures of the invention containing
50 to 100 phr of at least one synthetic rubber, in particular BR rubber and/or SBR rubber,
20 to 160 phr of at least one silica, especially having a specific surface area (BET) of 5 to 1000, preferably 20 to 400, m²/g and having primary particle sizes of 100 to 400 nm,
0.1 to 100 phr of at least one carbon black, especially having a specific surface area (BET) in the range from 20 to 200 m²/g,
0.5 to 10 phr of at least one crosslinker, especially from the group of sulfur donors and/or sulfur,
0.1 to 10 phr of zinc oxide,
0.5 to 10 phr of at least one vulcanization accelerator, especially from the group of sulfenamides,
0.1 to 10.0 phr of at least one secondary accelerator,
0.5 to 15 phr of at least one reinforcing additive, especially from the group of sulfur-containing silanes,
0.1 to 30 phr of rubber auxiliaries
and
0.5 to 10.0 phr of the at least one ethoxylated compound of formula (I).

The aforementioned further preferred ranges for the individual components also apply to these preferred mixtures.

### Process for Producing the Rubber Mixtures

The present invention further provides a process for producing the rubber mixtures according to the invention, characterized in that the respective components are mixed in a mixing process. This preferably comprises mixing at least one synthetic rubber, optionally at least one natural rubber and at least one ethoxylated compound of formula (I), optionally in the presence of at least one filler, optionally at least one crosslinker, optionally at least one vulcanization accelerator, optionally zinc oxide, optionally at least one secondary accelerator, optionally at least one reinforcing additive and optionally one or more of the rubber auxiliaries mentioned with one another in the general and preferred amounts mentioned for these additives at a temperature in the range from 30° C. to 170° C., particularly preferably from 140° C. to 160° C.

The rubber mixtures of the invention are produced in a customary manner in known mixing apparatuses, such as rollers, internal mixers, downstream mixing roller mills and mixing extruders, at shear rates of 1 to 1000 sec⁻¹.

Production of the rubber mixtures according to the invention is preferably carried out in a two-stage mixing process. In a first mixing stage the fillers and the at least one ethoxylated compound of formula (I) and optionally further aforementioned rubber auxiliaries are initially incorporated into the rubber in an internal mixer (kneader). Mixing temperatures in the internal mixer may achieve values up to 170° C. The mixing temperature in the internal mixer is preferably 130° C. to 170° C., particularly preferably 140° C. to 160° C.

This is preferably followed by so-called post-mastication, preferably at 130-170° C., particularly preferably at 150° C. The post-mastication may be carried out in a kneader or internal mixer for example.

In a second mixing stage crosslinkers, vulcanization accelerators and optionally further aforementioned rubber auxiliaries, preferably secondary accelerators and aging stabilizers, are added to the mixture obtained from the first mixing stage. The mixing temperature in the second mixing stage is preferably 50-150° C., preferably 55-140° C., in particular from 60° C. to 130° C.

The second mixing stage is preferably performed on a roller mill containing water-cooled rollers. This allows a lower mixing temperature than in the first mixing stage.

Addition of the at least one ethoxylated compound of formula (I) may be carried out at any time during the mixing, preferably in the first step of the mixing operation at a temperature in the range from 130° C. to 170° C., preferably at a temperature of 140 to 160° C.

The at least one ethoxylated compound of formula (I) may be employed either in pure form or else having been absorbed and/or adsorbed on an inert, organic or inorganic carrier, preferably a carrier selected from the group containing natural or synthetic silicates, in particular neutral, acidic or basic silica, aluminum oxide, carbon black or zinc oxide, in the mixing process.

### Bonding Mixtures

The present invention further provides bonding mixtures containing a rubber mixture according to the invention and at least one bonding agent.

The bonding mixtures according to the invention preferably contain at least one bonding agent based on resorcinol, formaldehyde and silica.

Combinations of resorcinol, formaldehyde and silica are known from the prior art as RFS direct bonding systems. The bonding mixtures of the invention may contain these direct bonding systems in any amount.

The bonding mixtures of the invention may be produced in a known manner by mixing a rubber mixture of the invention with at least one bonding agent based on resorcinol, formaldehyde and silica.

In the bonding agents, formaldehyde may be present in the form of formaldehyde donors. Suitable formaldehyde donors include not only hexamethylenetetramine but also methylolamine derivatives.

In order to improve bonding, one or more components capable of synthetic resin formation, such as phenol and/or amines and/or aldehydes or compounds that eliminate aldehydes, may be added to the bonding mixtures of the invention.

### Process for Producing Rubber Vulcanizates

Process for producing rubber vulcanizates, characterized in that the rubber mixture according to the invention is heated at temperatures of 120° C. to 200° C., preferably at 140° C. to 180° C.

The process for producing the rubber vulcanizates according to the invention may be performed over a wide pressure range, preferably at a pressure in the range from 10 to 200 bar.

The present invention further provides rubber vulcanizates obtainable by vulcanization of the rubber mixtures according to the invention.

The rubber vulcanizates according to the invention have an unexpectedly low rolling resistance, especially when used in tires, coupled with comparable performance characteristics.

In the context of the present invention the rolling resistance is determined via the loss factor tan δ at 60° C. by DIN 53513 dynamic damping.

### Shaped Articles

The rubber vulcanizates of the invention are suitable for production of all kinds of shaped articles, for example tire components, technical rubber articles such as damping elements, roller coverings, coverings of conveyor belts, drive belts, spinning cops, seals, golfball cores, footwear soles; they are especially suitable for production of tires and tire components, such as tire treads, subtreads, carcasses, sidewalls of tires, reinforced sidewalls for runflat tires, and apex mixtures. Tire treads also include treads of summer, winter and all-season tires and also treads of passenger car, truck and light-truck tires.

Preferred shaped articles are tires and tire parts containing a rubber vulcanizate according to the invention.

The present invention further provides for the use of the at least one ethoxylated compound of formula (I) for producing vulcanizates having a low rolling resistance made of sulfur-crosslinkable rubber mixtures, in particular in an amount of 0.5 to 10.0 phr at a vulcanization temperature of 120° C. to 200° C.

The present invention further provides for the use of the at least one ethoxylated compound of formula (I) in rubber mixtures, vulcanizates and shaped articles producible therefrom for reducing the rolling resistance of shaped articles made of rubber vulcanizates, preferably of tires and tire parts.

The descriptions and preferred ranges indicated for the components present and optionally present in the rubber mixture according to the invention, such as the at least one synthetic rubber, the at least one natural rubber, the at least one hydroxyl-containing oxidic filler, the at least one carbon black, the at least one crosslinker, the at least one vulcanization accelerator, the zinc oxide, the at least one secondary accelerator, the at least one reinforcing additive, the rubber auxiliaries and the at least one ethoxylated compound of formula (I), apply analogously inter alia for the disclosed processes and uses and the vulcanizates, shaped articles and bonding mixtures.

The indicated descriptions and preferred ranges likewise apply inter alia for the rubber mixtures, vulcanizates, shaped articles, bonding mixtures, processes and uses according to the invention irrespective of whether they were disclosed for the aforementioned in the plural (e.g. rubber mixtures) or in the singular (e.g. rubber mixture).

The invention is to be elucidated by the examples that follow, but without being limited thereto.

### EXEMPLARY EMBODIMENTS

TABLE 1
List of input materials, abbreviations and manufacturers

| Trade name | Description | Manufacturer/distributor |
|---|---|---|
| BUNAR CB 24 | Neodymium Butadiene | Arlanxeo Deutschland GmbH |
| | Rubber (BR) | |
| BUNA ® VSL 4526-2 HM | Styrene-butadiene rubber | Arlanxeo Deutschland GmbH |
| | (SBR) (oil-extended, oil | |
| | content 27.3% by weight) | |
| CORAX ® N 339 | Carbon black | Degussa-Evonik GmbH |
| TUDALEN ® 1849-TE | Process oil | Hansen & Rosenthal (H&R |
| | | GRUPPE) |
| PALMERA ® A9818 | Stearic acid | KLK OLEO |
| ANTILUX ® 654 | Wax | Lanxess Deutschland GmbH |
| VULKACIT ® CZ/C | N-Cyclohexyl-2- | Lanxess Deutschland GmbH |
| | benzothiazole-sulfenamide | |
| Avozinc-Rotsiegel (Pulver) | Zinc oxide | Avokal ® GmbH |
| MAHLSCHWEFEL 90/95 | Sulfur | Solvay Deutschland GmbH |
| CHANCEL | | |
| VULKANOX ® 4020/LG | N-1,3-dimethylbutyl-N′- | Lanxess Deutschland GmbH |
| | phenyl-p-phenylenediamine | |
| VULKASIL ® S | Silica | Lanxess Deutschland GmbH |
| VULKANOX ® HS | 2,2,4-trimethyl-1,2- | Lanxess Deutschland GmbH |
| | dihydroquinoline, polymerized | |
| | (TMQ) | |
| SI ® 69 | Bis(triethoxysilylpropyl) | Evonik Resource Efficiency |
| | tetrasulfane | GmbH |
| RHENOGRAN ® DPG-80 | N,N′-diphenylguanidine | Lanxess Deutschland GmbH |
| | (polymer-bound; containing | |
| | 80% DPG) | |
| LUTENSOL ® TO 5 | Ethoxylated isotridecanol | BASF |

### Production of the Rubber Vulcanizates

The rubber mixtures of noninventive example 1 were produced according to the composition of the reference mixture from EP2858831A1 and inventive examples 2 and 3 were produced according to the formulations specified in table 1.

Production of the rubber mixtures was carried out in the following steps:

### 1st Mixing Stage:

BUNA® CB 24 and BUNA® VSL 4526-2 HM are initially charged in an internal mixer and mixed for about 30 seconds.
Two thirds of the VULKASIL® S and two thirds of the SI® 69 were added and the mixture was mixed for about 60 seconds.
One third of the VULKASIL® S, one third of the SI® 69 and also TUDALEN® 1849-TE were added and the mixture was mixed for about 60 seconds.

CORAX® N 339, PALMERA® A9818, VULKANOX® 4020/LG, VULKANOX® HS, ZINKOXID (ROTSIEGEL), LUTENSOL® TO 5 were added and the mixture was mixed for about 60 seconds.

This mixing operation was carried out at a temperature of 150° C.

Upon termination of the first mixing stage the mixed batch was admitted to a downstream roller mill and shaped into a sheet, a strip or pellets and stored at room temperature for 24 hours.

Processing temperatures are 70° C.

This was followed by mixing at 150° C. in a kneader/internal mixer (the so-called post-mastication).

### 2nd Mixing Stage:

The addition of additives such as MAHLSCHWEFEL 90/95 CHANCEL, VULKACIT® CZ/C, Rhenogran® DPG-80 on a roller was carried out at 70° C.

TABLE 2
Rubber formulations

| Example | 1 | 2 | 3 |
|---|---|---|---|
| Inventive yes/no | no | yes | yes |
| BUNA ® CB 24 | 30 | 30 | 30 |
| BUNA ® VSL 4526-2 HM | 96 | 96 | 96 |
| CORAX ® N 339 | 6.4 | 6.4 | 6.4 |
| TUDALEN ® 1849-TE | 8 | 8 | 8 |
| PALMERA ® A 9818 | 1 | 1 | 1 |
| ANTILUX ® 654 | 1.5 | 1.5 | 1.5 |
| AVOZINC Rotsiegel | 2.5 | 2.5 | 2.5 |
| VULKACIT ® CZ/C | 1.5 | 1.5 | 1.5 |
| MAHLSCHWEFEL 90/95 CHANCEL | 1.5 | 1.5 | 2.1 |
| VULKANOX ® 4020/LG | 1 | 1 | 1 |
| VULKANOX ® HS | 1 | 1 | 1 |
| RHENOGRAN ® DPG-80 | 2.5 | 2.5 | 2.5 |
| SI ® 69 | 6.4 | 6.4 | 6.4 |
| VULKASIL ® S | 80 | 80 | 80 |
| LUTENSOL ® TO 5 | 0 | 5.0 | 5.0 |

### Technical Testing

The vulcanizates produced at 170° C. from the rubber mixtures of examples 1 to 3 were subjected to the technical tests specified below. The determined values are reported in table 3.

Very good properties of the rubber mixtures/their vulcanizates have been achieved when their properties are within the specified “preferred range”.

The tests on test specimens employed the following test methods:

### Employed Rheometer (Vulcameter) and Scorch/Full Vulcanization Time

The MDR (moving die rheometer) vulcanization profile and analytical data associated therewith are measured in an MDR 2000 Monsanto rheometer in accordance with ASTM D5289-95.

The scorch time (15) is the time at which 5% of the rubber is crosslinked. The temperature chosen was 130° C.

The complete vulcanization time (195) is the time at which 95% of the rubber is crosslinked. The temperature chosen was 170° C.

### Determination of 300 Modulus

These measurements were made according to DIN 53504 (tensile test S2 rod) at a temperature of 23° C.

### Determination of Shore-A Hardness

The measurements were made at room temperature (RT) according to DIN 53 505.

### Determination of Rolling Resistance

The loss factor tan δ was determined at 60° C. by DIN 53513 dynamic damping.

TABLE 3
Test values

| Example | 1 | 2 | 3 |
|---|---|---|---|
| Inventive yes/no | no | yes | yes |
| Scorch time (15) [s] | 1279 | 1342 | 1234 |
| Full vulcanization time (195) [s] | 1157 | 708 | 688 |
| 300 modulus [MPa] | 15.7 | 13.5 | 15.7 |
| Hardness [Shore A] | 69 | 68 | 69 |
| Loss factor tan δ at 60° C. | 0.117 | 0.113 | 0.100 |

### CONCLUSION

It has surprisingly been found that the inventive rubber mixtures according to examples 2 and 3 achieve a shorter complete vulcanization time (195) and a markedly lower loss factor tan δ at 60° C. compared to the noninventive rubber mixture of example 1 (corresponding to composition of reference mixture from EP2858831A1) coupled with virtually unchanged further mechanical properties. The inventive mixture 3 achieved a lower loss factor tan δ at 60° C. compared to the noninventive rubber mixture of example 1 at identical 300 modulus and hardness.

The inventive rubber mixtures according to examples 2 and 3 even achieved an improved scorch time (15) compared to rubber formulation 1 from EP2858831A1 and the inventive rubber mixture according to example 3 even achieved a lower loss factor tan δ at 60° C.

The inventive rubber mixtures 2 and 3 do not show any speckling on the surface and good mixing of the employed additives is therefore assumed.

1. A rubber mixture comprising
50 to 100 phr of at least one synthetic rubber,
0 to 50 phr of at least one natural rubber,
0.1 to 200 phr of at least one hydroxyl-containing oxidic filler,
0 to 120 phr of at least one carbon black,
0.1 to 20 phr of at least one crosslinker,
and
0.5 to 10 phr of at least one ethoxylated compound of formula (I) 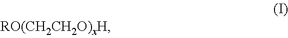
wherein
R represents alkyl, wherein alkyl may be branched or unbranched,
and
x represents an integer from 1 to 20.

2. The rubber mixture as claimed in claim 1, wherein R represents C₁-C₂₀-alkyl.

3. The rubber mixture as claimed in claim 1, wherein x represents an integer from 2 to 15.

4. The rubber mixture as claimed in claim 1, wherein the at least one synthetic rubber is selected from the group consisting of polar and non-polar synthetic rubbers.

5. The rubber mixture as claimed in claim 1, wherein the at least one hydroxyl-containing oxidic filler is selected from the group consisting of silicas, synthetic silicates and natural silicates and is present in the rubber mixture in an amount of 0.1 to 200 phr.

6. The rubber mixture as claimed in claim 1, wherein the rubber mixture contains 0.1 to less than 1.8 phr of sulfur in the at least one crosslinker.

7. The rubber mixture as claimed in claim 1, wherein the rubber mixture contains 1.8 to 20 phr of sulfur in the at least one crosslinker.

8. The rubber mixture as claimed in claim 1, wherein the rubber mixture contains at least one reinforcing additive from the group of sulfur-containing organic silanes.

9. The rubber mixture as claimed in claim 1, wherein the rubber mixture contains
50 to 100 phr of at least one synthetic rubber,
20 to 160 phr of at least one silica, having primary particle sizes of 100 to 400 nm,
0.1 to 100 phr of at least one carbon black,
0.5 to 10 phr of at least one crosslinker,
0.1 to 10 phr of zinc oxide,
0.5 to 10 phr of at least one vulcanization accelerator,
0.1 to 10.0 phr of at least one secondary accelerator,
0.5 to 15 phr of at least one reinforcing additive,
0.1 to 30 phr of rubber auxiliaries
and
0.5 to 10.0 phr of the at least one ethoxylated compound of formula (I).

10. A process for producing the rubber mixtures as claimed in claim 1, wherein the respective components are mixed in a mixing process.

11. A method of producing vulcanizates and rubber shaped articles of all kinds comprising incorporating the rubber mixtures as claimed in claim 1 into the vulcanizates and rubber shaped articles of all kinds.

12. A vulcanizate obtained by vulcanization of at least one rubber mixture as claimed in claim 1.

13. A vehicle tire, wherein the vehicle tire has at least one vulcanizate as claimed in claim 12.

14. A method of producing vulcanizates incorporating at least one ethoxylated compound of formula (I) 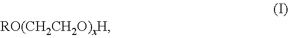
wherein
R represents alkyl, wherein alkyl may be branched or unbranched,
and
x represents an integer from 1 to 20,
into the vulcanizates, wherein the vulcanizates have a low rolling resistance from sulfur-crosslinkable rubber mixtures at a vulcanization temperature of 120° C. to 200° C.

15. A method for reducing the rolling resistance of shaped articles made of rubber vulcanizates by incorporating at least one ethoxylated compound of formula (I) 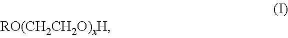
wherein
R represents alkyl, wherein alkyl may be branched or unbranched,
and
x represents an integer from 1 to 20,
into rubber mixtures, vulcanizates and shaped articles obtainable therefrom.
